(19) United States
(12) Patent Application Publication
(10) Pub. No.: US 2010/0100570 A1
(43) Pub. Date: Apr. 22, 2010

(54) Document Set with Workflow Binding Ability on Each Element and the Whole Set

(76) Inventors: Michael Constantin, Irvine, CA (US); Weihsiung William Chow, Cerritos, CA (US); David J. Lovat, Huntington Beach, CA (US)

Correspondence Address: MICHAEL BLAINE BROOKS, PC, P.O. BOX 1630, SIMI VALLEY, CA, 93062-1630, US

(21) Appl. No.: 12/255,240

(22) Filed: Oct. 21, 2008

(51) Int. Cl. G06F 17/30

(52) U.S. Cl. 707/803; 707/E17.009

(57) ABSTRACT

Systems, methods, and computer-readable media for executing workflow via one or more workflow components to enable particular workflow components while fully supporting the execution of a complete workflow by selecting an element of a first document set, selecting an element of a second document set, and establishing a binding relationship between the element of the first document set and the element of the second document set.

### FIELD OF ENDEAVOR

The present invention in its several embodiments relates generally to data binding in a workflow architecture, and more particularly to binding documents of workflow components.

### BACKGROUND

In a workflow built with a component-based workflow infrastructure, a property of a workflow activity, e.g., an activity on the data consumer end of a workflow component, can be bound to a property of another workflow activity, e.g., an activity on the data provider end of the second workflow component, so that the value of those two properties can be made consistent. Within document automation systems, files can be processed via activities either individually, or as groups, or as sets, of documents. An operative presumption is that all of the documents in a document set are from a single activity, acting as a data provider, and that once processed according to a present activity, the output documents will be consumed by another single activity, acting as a data consumer. Accordingly, a workflow activity involving documents, i.e., a document-dealing activity, typically has one or more properties defined for the documents as a document set. Generally, binding is associating two or more programming object or value items for a period of time. So the state of the art has all documents within a document set treated the same in terms of property binding.

Some workflow components, particularly activities pertaining to documents, handle documents collectively having a wide range of types, while some other activities pertaining to documents exclusively handle a specific document type. This diversity of document types across workflow components is presently neglected by the level at which property values are bound and sustains an unnecessary complexity and inconvenience for document automation system functionality.

The above presumption, in action, may be illustrated in a scenario where a collection of related documents are being scanned into a workflow. In this scenario, it is desirous to start specific processes for scanned documents of specific types that are different from other scanned documents having other specific types. The scan activity may scan several types of documents and provide all the documents in a document set to any downstream activities. So practically, this might mean sending to an invoice processing activity the scanned invoice documents along with the other documents of the document set, sending to a shipping processing activity the scanned shipping notes along with the other documents of the document set, and sending to a billing process the scanned billing statements along with the other documents of the document set. However, document downstream activity of a workflow is limited to document format. That is, the invoice activity can only work on a document in invoice format neglecting the remainder of the documents of the document set, the shipping activity can only work on a document in the shipping format, and the billing activity can only work on a document in the billing format.

FIG. 1 illustrates the prior art architecture 100 where in a workflow environment, workflow_1 comprises workflow component_1 110 and workflow component_2 120, each comprising document_1 and document_2 and where the data binding is from the document set of workflow component_1 to workflow component_2. That is, the state of the art has the binding of an “input document” of component_2, i.e., a target property of component_2, to the “output document” property, i.e. the source property, of component_1. A pseudocode representation of the prior art binding may be as follows:

input_document=bind(component=component1,property=output_document)

FIG. 1B illustrates in a flowchart 150 the prior art where for the target or input document, the binding at the document set has the input document property of component_2 associated with the output document property of component_1. Due to the diversity of document formats within a document set, the entire document set does not avail itself for conventional binding to a particular downstream activity. In addition, while the state of the art provides for binding to an entire document set or to none at all, the state of the art does not provide for a way to bind a particular downstream activity to just part of the document set.

### SUMMARY

This invention in its several embodiments pertains to document automation workflow by allowing the user to group a collection of documents into a document set and bind each individual document in the set to potentially a different data source. The exemplary embodiments of the invention provided herein are systems, methods, and computer-readable media for executing workflow by selecting an element of a first document set, selecting an element of a second document set; and establishing a binding relationship between the element of the first document set and the element of the second document set. The element of the first document set may be a document data element and the element of the second document set may be a document data element.

### BRIEF DESCRIPTION OF THE DRAWINGS

Embodiments of the present invention are illustrated by way of example and not limitation in the figures of the accompanying drawings, and in which:

FIG. 1A is a graphical depiction of prior art data binding;

FIG. 1B is a flowchart of prior art binding;

FIG. 2 is a functional block diagram depiction of a computing device configured according to an exemplary embodiment of the present invention;

FIG. 3 is a graphical depiction of a data binding embodiment of the present invention;

FIG. 4 is a flowchart of a data binding embodiment of the present invention;

FIG. 5 is a graphical depiction of a data binding embodiment of the present invention;

FIG. 6 is a flowchart of a data binding embodiment of the present invention;

FIG. 7 is a graphical depiction of a data binding embodiment of the present invention; and

FIG. 8 is a flowchart of a data binding embodiment of the present invention.

### DETAILED DESCRIPTION

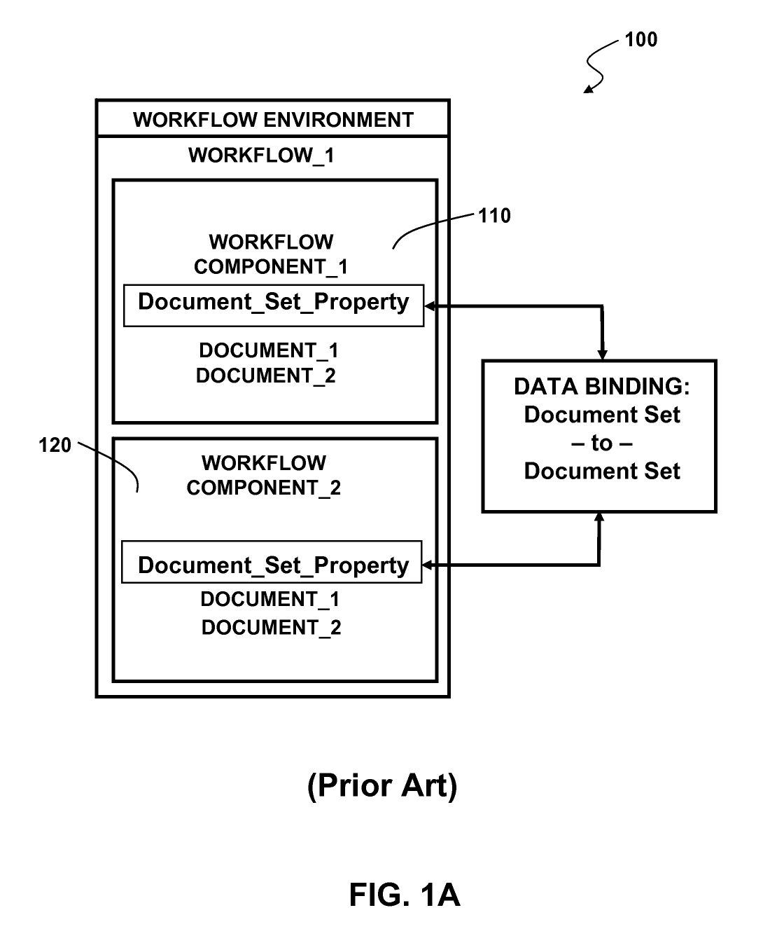

Beyond the prior art example of FIGS. 1A and 1B, the front end scanning of the diversity of documents may be broken into several scan activities for each of the types of documents, where each scan activity could scan a particular type of document and feed the scanned documents of a particular type or format to a particular downstream activity. Embodiments of the present invention support a workflow process that may group sets of documents, e.g., scanned documents, whether activity related or not related, or whether containing common subject matter or having a common origin but disparate in document format types. In addition to the grouping of sets of documents, embodiments of the present invention may set up a binding relationship at the level of the whole, i.e., entire, document set and also at the level of each individual element in the document set.

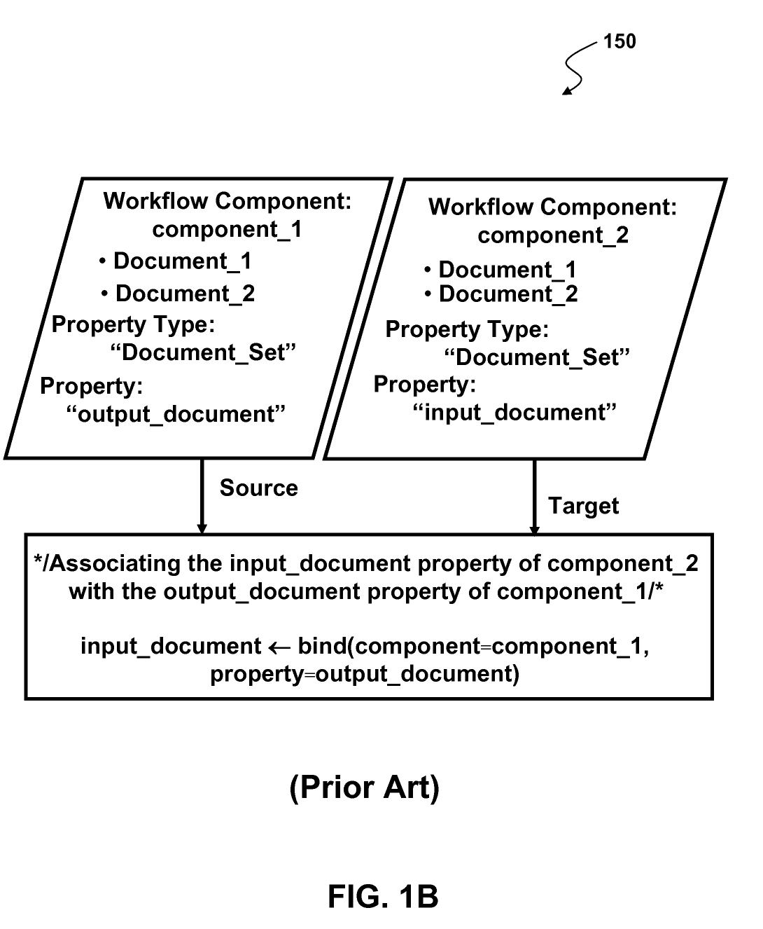

Embodiments of the present invention may be executed via a computer device, such as the one shown in FIG. 2. The exemplary computing device 200 comprises a processor 210 such as a central processing unit (CPU), addressable memory 220 and a user interface 230. These elements may be in communication with one another via a data bus 240. Via an operating system 250, the processor 210 may be configured to execute steps of a workflow environment 260 according to the exemplary embodiments of the present invention.

Examples of the present invention have a workflow as an executable program having components where the components are the language constructs of the workflow. Accordingly, a workflow framework provides the infrastructure for building a workflow from individual workflow components specific to a problem domain, and as such provides a runtime environment for executing the workflow and many other supporting services, e.g. design-time experience, persistence, and security. An exemplary operating environment may be a document management system built with Microsoft™ Workflow Foundation™. Accordingly, one or more actual workflows may be built and executed using the above framework which may implement portions or all of a desired functionality of an application. The resulting applications may host the runtime execution environment and also support a user interface.

For example, some embodiments of the present invention may be used (not necessarily in the following order): (a) setup binding to individual elements of a set of documents; (b) setup binding to the document as a whole, i.e., as an entire logical data entry; (c) establish, at the individual document level, data references for modification; (d) combine and distribute modified documents as a single logical data entity that may also comprise unmodified documents.

An embodiment of the present invention may be a document management workflow system that: (a) collects input electronic documents from data sources, e.g., a multifunction peripheral (MFP) having a scanner, email, particularly email attachments, an FTP site, and a shared folder; (b) processes the input documents, e.g., reformat, stamp, optical character recognition (OCR), and data extraction; and (c) distributes processed and/or unprocessed documents to data destinations, e.g., an MFP printer, email, database, the Microsoft™ Office SharePoint™ server, and a shared folder. At design time, binding may be established between either a set comprising multiple documents, or binding may be established from a single document of a set, to a single document of another set.

The functionality to setup binding to individual elements of a group, or set of documents, yet retain the ability of establishing binding to the document set as a whole logical data entity, includes the functionality of the processing workflow to reference and modify data from each individual document, and then combine and distribute modified or unmodified documents as a single logical data entity. An example of such a document set is one that may comprise: (a) one or more scanned images from an MFP scanner; (b) one or more files retrieved from a database; and (c) one or more documents taken as attachments of one or more emails received by the exemplary workflow; where all of these files are combined and passed as a single data entity to downstream workflow activities for further processing.

In some embodiments, the workflow process may merge files, or data elements, from multiple sources such as an image scanned from an MFP device, a database, or file on a server into a single logical data entity, and then distribute the data/files to activities regardless whether an activity is enabled to process all or part of data of the single logical data entity.

The functionality of a document automation workflow is to collect data from various data sources and organize the data into a document set as a single logical data entity and then to distribute the data to various activities/components along the processing flow. Functionality may be present for workflow activities to refer, modify, retrieve and contribute data to or from individual or all documents in the document set. Functionality may be present for the output to be a synthesis of all of the input documents, or for the output to be a set of modified or unmodified data or documents.

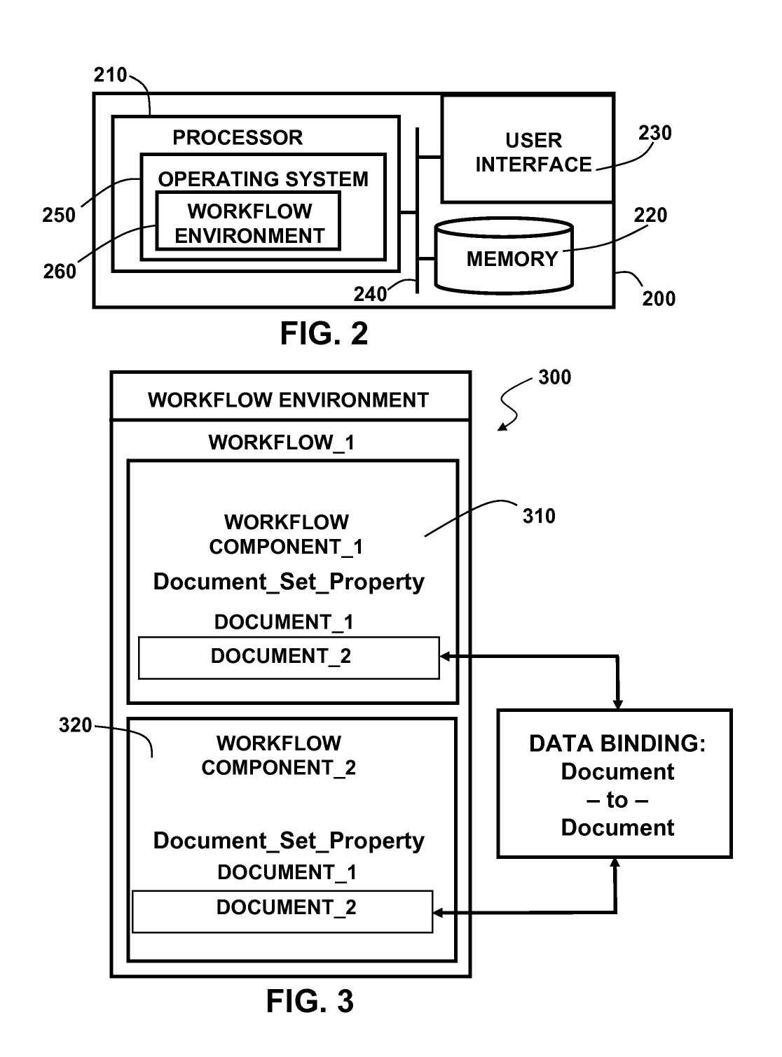

FIG. 3 illustrates an exemplary architectural embodiment 300 of the present invention, as the one-to-one binding of documents, each of different workflow components, where workflow_1 comprises workflow component_1 310 and workflow component_2 320, each comprising document_1 and document_2. In this example, workflow component_1 310 has an “output document” property which is of Document_Set property type with two documents: document_1 and document_2. Also in this example workflow component_2 320 has an “input document” property that is of Document_Set property type and with two documents: document_1 and document_2.

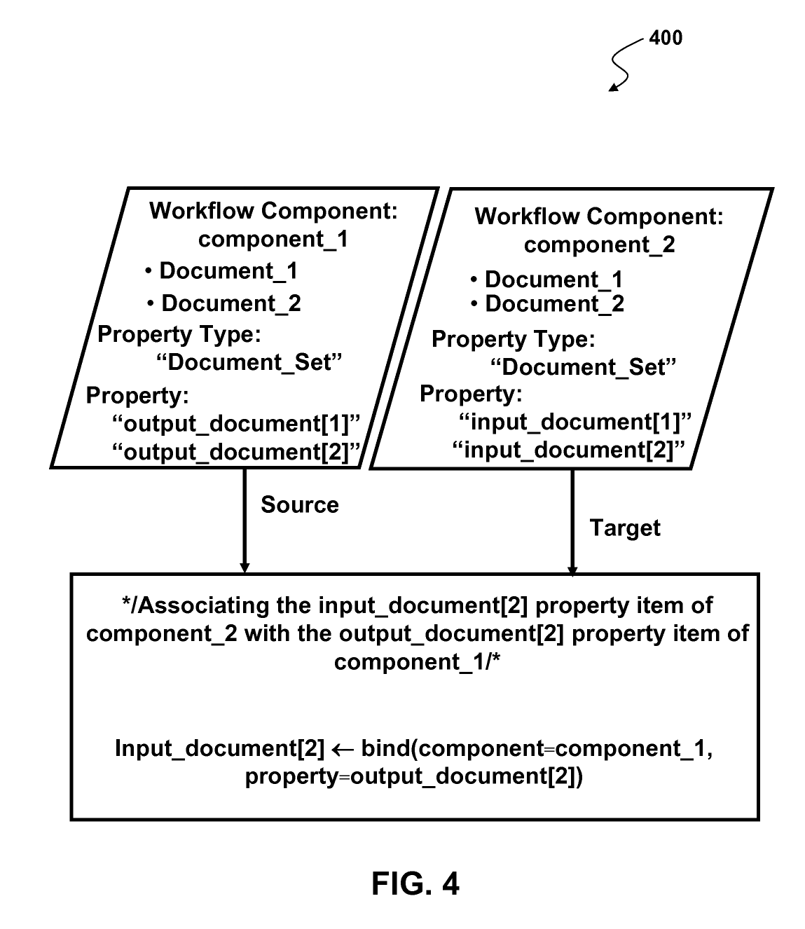

FIG. 4 illustrates in a flowchart 400 where for the target or input document, the binding of the selected or identified document_2 item or element of the input document property of component_2, i.e., the target property of the document_2 item, to the selected or identified document_2 item or element of the output document property of component_1, i.e., the source property of the document_2 property.

Exemplary pseudocode of this embodiment may be as follows:

input_document.document2 =
bind(component=component1,property=output_document.document2)

or, using arrays or vectors:

input_document[2] =
bind(component=component1,property=output_document[2])

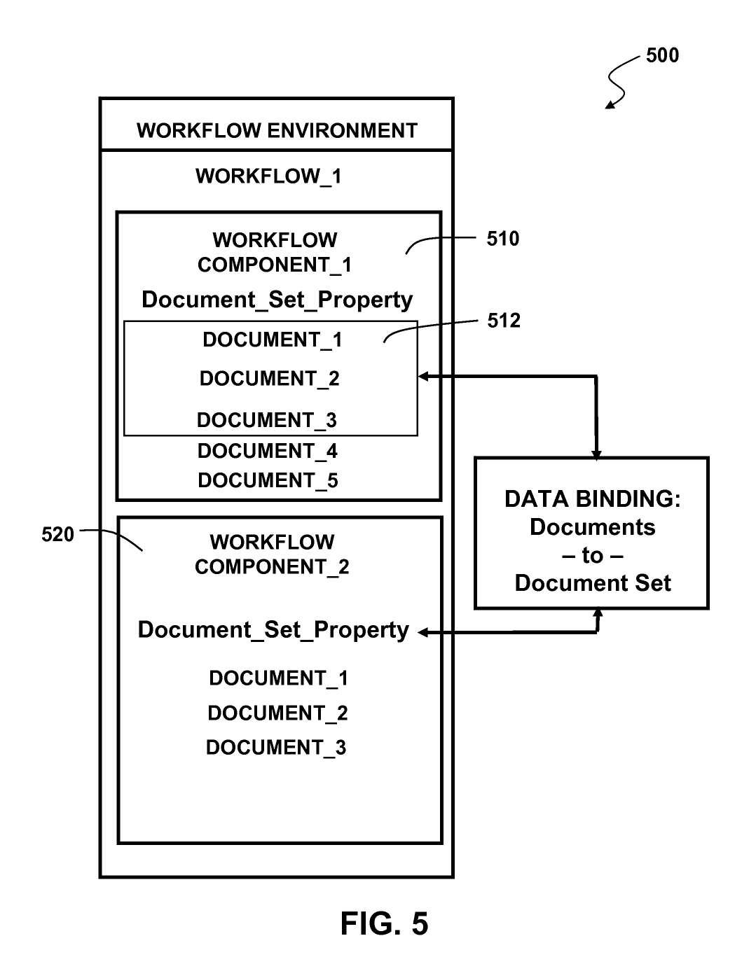

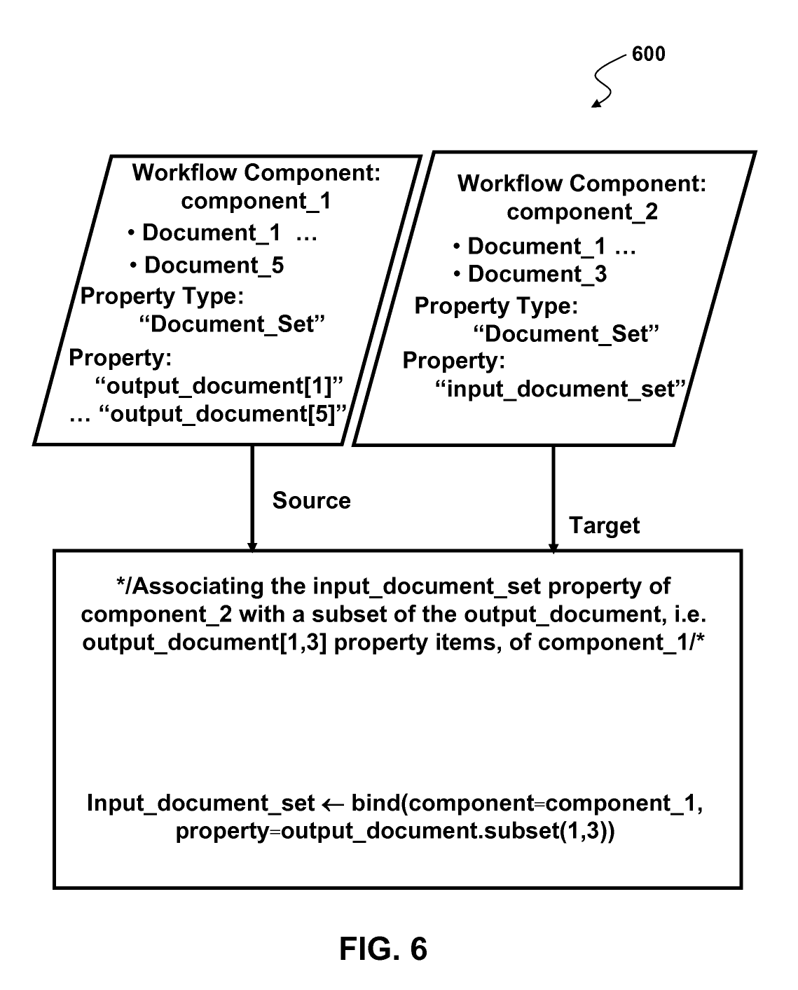

FIG. 5 illustrates another exemplary embodiment 500 of the present invention where the output document (workflow component_1 510) has five documents, i.e., document_1, document_2, . . . , document_5. Binding the input document of workflow component_2 520, i.e., the target property, to a subset 512 of workflow component_1 510 comprising document_1, document_2, and document_3 of the output document property of component_1 510, i.e., the source property, may be illustrated in the flowchart 600 of FIG. 6.

Exemplary pseudocode of this document-subset-to-document-subset binding embodiment may be as follows:

input_document_set =
bind(component=component1,property=
output_document.subset(document1, document2, document3))

or, using arrays or vectors:

input_document_set =
bind(component=component1,property=output_document.subset(1,3)).

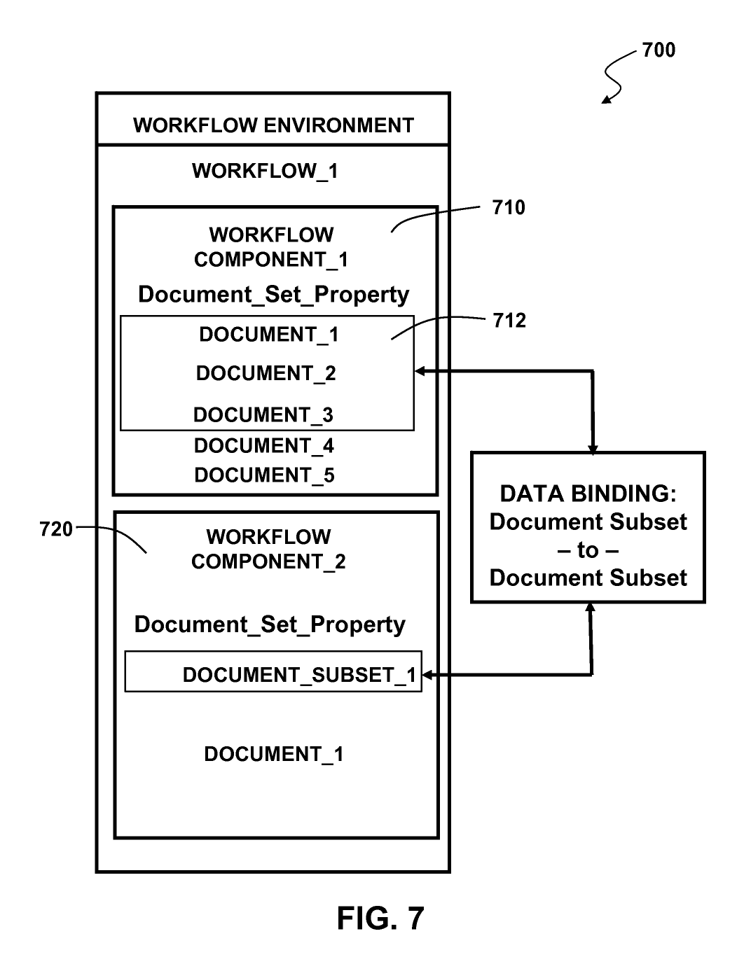

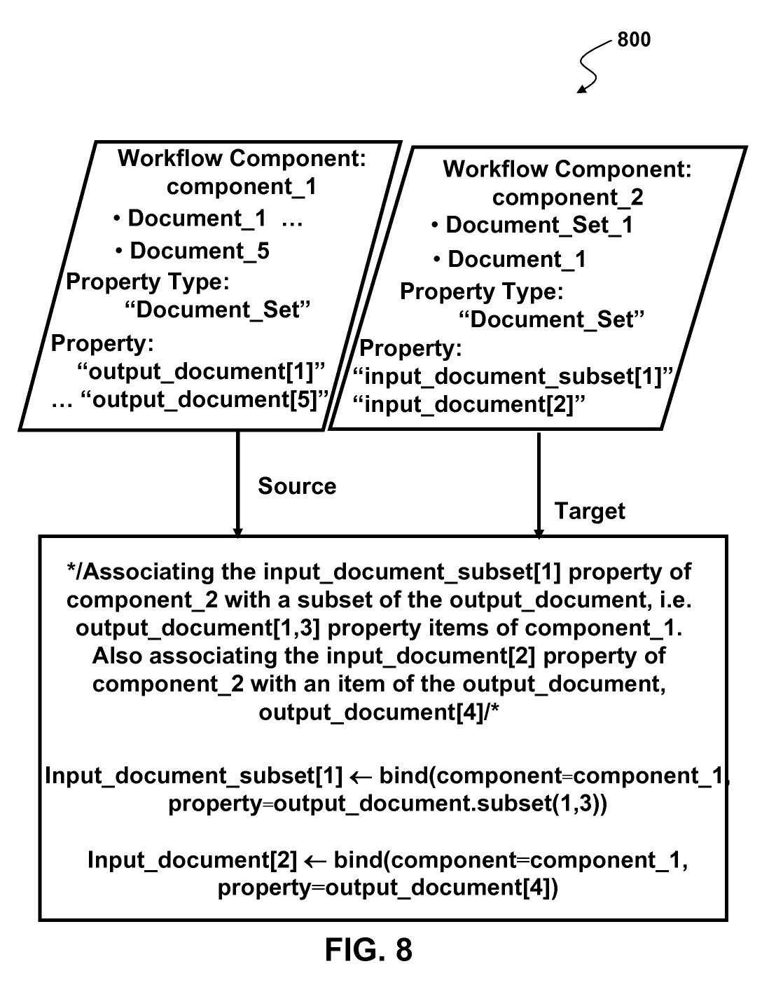

Illustrated in FIG. 7 is another exemplary embodiment 700 of the present invention, a document subset binding to document subset binding, where the output document (workflow component_1 710) has five documents, i.e., document_1, document_2, . . . , document_5. Binding the input document set of workflow component_2 720, i.e., the target property, to a subset 712 of workflow component_1 710 comprising document_1, document_2, and document_3 of the output document property of component_1 710, i.e., the source property, may be illustrated in the flowchart 800 of FIG. 8.

Exemplary pseudocode of this embodiment may be as follows:

```
input_document_set[1] =
    bind(component=component1,property=
        output_document.subset(document1,3))
and
    input_document[2]=
        bind(component=component1,property=output_document.[4]).
```

Based on the foregoing, it should be appreciated that provided herein are systems, methods, and computer-readable media for executing workflow by identifying a first element of a first document set, identifying a first element of a second document set; and establishing a binding relationship between the first element of the first document set and the first element of the second document set. One of ordinary skill in the art will also appreciate that the modules and functions described herein may be further subdivided, combined, and/or varied and yet still be in the spirit of the embodiments of the invention. In addition, while a number of variations of the invention have been shown and described in detail, other modifications, which are within the scope of this invention, will be readily apparent to those of ordinary skill in the art based upon this disclosure, e.g., the exemplary flowcharts or processes described herein may be modified and varied and yet still be in the spirit of the invention. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A computing device comprising:
a processing unit and addressable memory;
wherein the processing unit is configured to execute one or more instructions of:
select an element of a first document set;
select an element of a second document set; and
establish a binding relationship between the element of the first document set and the element of the second document set.

2. The computing device of claim 1 wherein the element of the first document set is a document data element and the element of the second document set is a document data element.

3. A machine-enabled method of workflow processing comprising:
selecting an element of a first document set;
selecting an element of a second document set;
establishing a binding relationship between the element of the first document set and the element of the second document set; and
outputting a workflow component comprising the second document set having the bound element of the first document set with the element of the second document set.

4. The machine-enabled method of workflow processing of claim 3 wherein the element of the first document set is a document data element and the element of the second document set is a document data element.

5. A computer-readable medium having computer-executable instructions stored thereon which, when executed by a computer, are operative to cause the computer, by performing one or more instructions to:
select an element of a first document set;
select an element of a second document set; and
establish a binding relationship between the element of the first document set and the element of the second document set.

6. The computer-readable medium of claim 5 wherein the element of the first document set is a document data element and the element of the second document set is a document data element.
